(19) United States
(12) Patent Application Publication
(10) Pub. No.: US 2017/0118286 A1
(43) Pub. Date: Apr. 27, 2017

(54) NON-TRANSITORY COMPUTER-READABLE STORAGE MEDIUM, EXCLUSIVE SWITCHING METHOD AND EXCLUSIVE SWITCHING APPARATUS

(71) Applicant: FUJITSU LIMITED, Kawasaki-shi (JP)

(72) Inventor: Kazuhito MATSUDA, Kawasaki (JP)

(73) Assignee: FUJITSU LIMITED, Kawasaki-shi (JP)

(21) Appl. No.: 15/293,705

(22) Filed: Oct. 14, 2016

(30) Foreign Application Priority Data
Oct. 21, 2015 (JP) 2015-207109

(51) Int. Cl. H04L 29/08; H04W 48/04; H04W 72/04; H04L 12/927

(52) U.S. Cl. CPC H04L 67/1097; H04L 47/80; H04W 48/04; H04W 72/048

(57) ABSTRACT

A non-transitory computer-readable storage medium storing an exclusive switching program that causes a computer to execute a process including obtaining supply information indicating a plurality of quantities of resources being available in a plurality of regions respectively, obtaining demand information indicating a plurality of demand quantities of the resources for the plurality of regions respectively, calculating a plurality of index values corresponding to the plurality of regions respectively based on the supply information and the demand information, each of the plurality of index values indicating probability of a collision of the resources in each of the plurality of regions, and determining, for each of a plurality of regions, a lock method to be applied in an exclusive access control for the resources based on the plurality of index values among from a plurality of lock methods.

### CROSS-REFERENCE TO RELATED APPLICATION

This application is based upon and claims the benefit of priority of the prior Japanese Patent Application No. 2015-207109, filed on Oct. 21, 2015, the entire contents of which are incorporated herein by reference.

### FIELD

The embodiment discussed herein is related to a non-transitory computer-readable storage medium, an exclusive switching method and an exclusive switching apparatus.

### BACKGROUND

A service is available which lends a resource requested by a user in a geographic region. In an example, the resource is a smartphone including a temperature sensor, and the user is an enterprise which calculates and provides an average temperature in a region. The enterprise borrows a smartphone in a region, an average temperature in which is desired to be provided, collects pieces of temperature data, and calculates and provides the average temperature. In another example, the resource is a vehicle-mounted display apparatus, and the user is an enterprise which desires to put an advertisement. The enterprise borrows a vehicle-mounted display apparatus in a region where an advertisement is desired to be put and displays the advertisement.

A service provider manages a resource for each region in advance and lends a resource in a region included in a resource request from a user. Since a resource is used by a plurality of users, the service provider has to perform exclusive control at the time of lending a resource.

FIG. 22 is a diagram for explaining resource exclusive control. In FIG. 22, a resource user 4 requests a desired quantity of resources 3 in a geographic region 9. A resource provider 8 registers the resource 3 to be provided in a service provider. As illustrated in FIG. 22, a resource 3a is in two regions, from which two respective resource users 4 request the resource 3. Thus, the two resource users 4 may fight over the resource 3a.

If such a fight over the resource 3 occurs, a collision occurs in a database which manages resources. FIG. 23 is a diagram for explaining a collision in a resource pool DB. The resource pool DB here is a database storing a piece of information on the resource 3. The resource pool DB stores a status of lending of the resource 3 using an identifier for identification of the resource 3. In FIG. 23, a resource_id is an identifier for identification of the resource 3, and a use_state is a piece of information indicating a status of lending of the resource 3. Examples of the piece of information indicating the status of lending of the resource 3 include “used” indicating that the resource 3 is lent out and “free” indicating that the resource 3 is not lent out.

As illustrated in FIG. 23, the resource 3 whose resource_id is “resource_02” is not lent out, and allocation of the resource 3 is requested by user A and user B. For this reason, a collision occurs in the resource pool DB over access to “resource_02”, and exclusive control is desired to ensure database consistency.

Examples of exclusive control for ensuring database consistency include pessimistic locking and optimistic locking. FIGS. 24A to 24C are charts for explaining pessimistic locking and optimistic locking. FIG. 24A illustrates pessimistic locking, FIG. 24B illustrates optimistic locking without collision, and FIG. 24C illustrates optimistic locking with collision. In FIGS. 24A to 24C, DB denotes a database, and access A and access B each denote access to data of DB. In FIGS. 24A to 24C, “Access” represents access to the database, “ObjectA” and “ObjectB” represent pieces of data to be accessed, “Success” represents success in access, “Abort” represents failure in access, and “additional” represents an excess of time over a time for a case without any collision.

As illustrated in FIG. 24A, in pessimistic locking, if a collision occurs at the time of access, later access is made to wait until earlier access is completed. That is, if access to “ObjectA” as access A occurs, and access to “ObjectA” as access B occurs before the access to “ObjectA” as access A is completed, access B is made to wait until access A is completed. For this reason, the access as access B is started after “Success” in access A and takes extra time corresponding to a waiting time.

As illustrated in FIG. 24B, in optimistic locking without collision, later access is executed without being made to wait until earlier access is completed, and ends successfully. That is, even if access to “ObjectA” as access A occurs, and access to “ObjectB” as access B occurs before access to “ObjectA” as access A is completed, access B is not made to wait until access A is completed. For this reason, the access as access B is executed without any waiting time and takes no extra time.

As illustrated in FIG. 24C, in optimistic locking with collision, later access is executed without being made to wait until earlier access is completed, and ends in failure. Thus, the later access has to be executed again. That is, even if access to “ObjectA” as access A occurs, and access to “ObjectA” as access B occurs before the access to “ObjectA” as access A is completed, access B is not made to wait until access A is completed. However, the access as access B fails due to a collision, and the access as access B is performed again after notification of the failure. Thus, the access as access B takes extra time corresponding to one access operation.

Hence, processing times for pessimistic locking and optimistic locking have the relation “optimistic locking without collision<pessimistic locking<optimistic locking with collision”. That is, if a collision occurs with high frequency, pessimistic locking is likely to be shorter in processing time. On the other hand, if a collision occurs with low frequency, optimistic locking is likely to be shorter in processing time.

For this reason, a technique is available for predicting collision frequency for each table or each row of a database and switching between optimistic locking and pessimistic locking. A technique is also available for improving performance by dynamically selecting a lock method in accordance with the tendency and load of access. A technique is also available for curbing an increase in the amount of machine resource consumption by calculating a waiting time for re-execution in a case where commitment of a transaction is unsuccessful and making a transaction wait to be re-executed until the waiting time elapses in the case where commitment of the transaction is unsuccessful.

Japanese Laid-open Patent Publication No. 2009-37544 and Japanese Laid-open Patent Publication No. 2013-45356 are examples of related art.

M. Sheikhan and S. Ahmadluei, “An intelligent hybrid optimistic/pessimistic concurrency control algorithm for centralized database systems using modified GSA-optimized ART neural model”, Neural Computing and Applications, Volume 23, Issue 6, pp. 1815-1829, 2013 is an example of related art.

### SUMMARY

According to an aspect of the invention, a non-transitory computer-readable storage medium storing an exclusive switching program that causes a computer to execute a process including obtaining supply information indicating a plurality of quantities of resources being available in a plurality of regions respectively, obtaining demand information indicating a plurality of demand quantities of the resources for the plurality of regions respectively, calculating a plurality of index values corresponding to the plurality of regions respectively based on the supply information and the demand information, each of the plurality of index values indicating probability of a collision of the resources in each of the plurality of regions, and determining, for each of a plurality of regions, a lock method to be applied in an exclusive access control for the resources based on the plurality of index values among from a plurality of lock methods.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1A is a first diagram illustrating the configuration of a resource allocation system according to an embodiment;

FIG. 1B is a second diagram illustrating the configuration of a resource allocation system according to the embodiment;

FIG. 2 is a diagram illustrating the functional configuration of a resource allocation apparatus;

FIG. 3 is a diagram for explaining division into cells;

FIG. 4 is a chart illustrating an example of a demand map;

FIG. 5 is a chart illustrating an example of updating of the demand map;

FIG. 6 is a chart illustrating an example of a supply map;

FIG. 7 is a chart illustrating an example of updating of the supply map;

FIG. 8 is a chart illustrating an example of an allocation map;

FIG. 9 is a chart illustrating an example of creation of the allocation map;

FIG. 10 is a chart for explaining a method for updating the allocation map;

FIG. 11 is a chart illustrating an example of a collision probability map;

FIG. 12 is a chart illustrating an example of a lock strategy map;

FIG. 13 is a chart illustrating an example of creation of the collision probability map and the lock strategy map;

FIG. 14 is a chart illustrating a correlation among maps;

FIG. 15 is a flowchart illustrating the flow of a resource registration process;

FIG. 16 is a flowchart illustrating the flow of a resource allocation process;

FIG. 17 is a flowchart illustrating the flow of a resource state information updating process;

FIG. 18 is a flowchart illustrating the flow of a resource reallocation process;

FIG. 19 is a flowchart illustrating the flow of a process of maintaining the allocation map and the collision probability map if a change in the demand map is found;

FIG. 20 is a flowchart illustrating the flow of a process of maintaining the allocation map and the collision probability map if a change in the supply map is found;

FIG. 21 is a diagram illustrating the hardware configuration of a computer which executes an exclusive switching program according to the embodiment;

FIG. 22 is a diagram for explaining resource exclusive control;

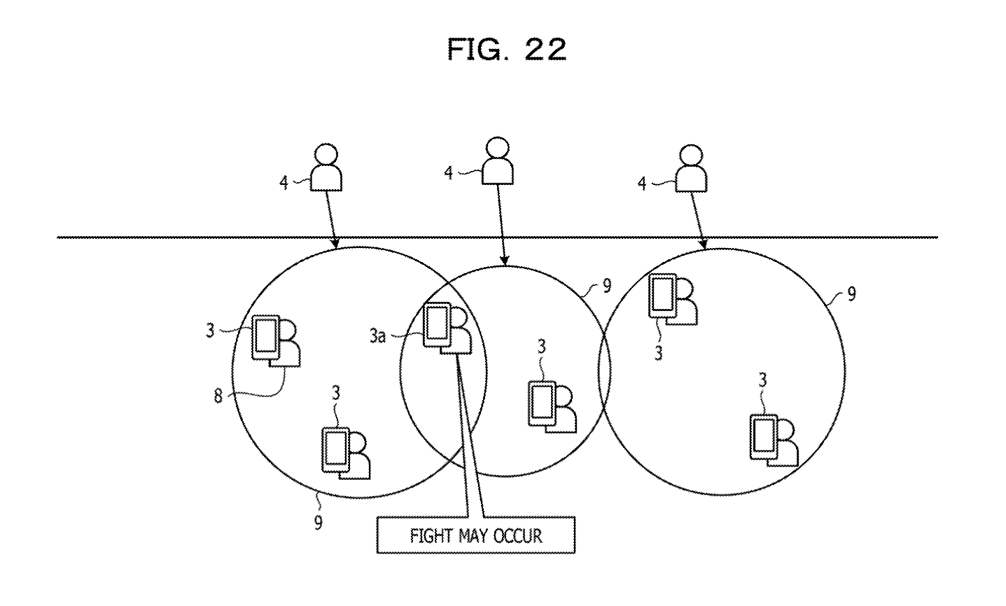

FIG. 23 is a diagram for explaining a collision in a resource pool DB; and

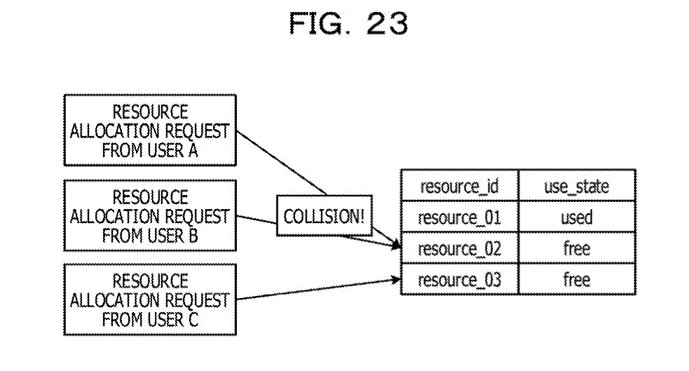

FIGS. 24A to 24C are charts for explaining pessimistic locking and optimistic locking.

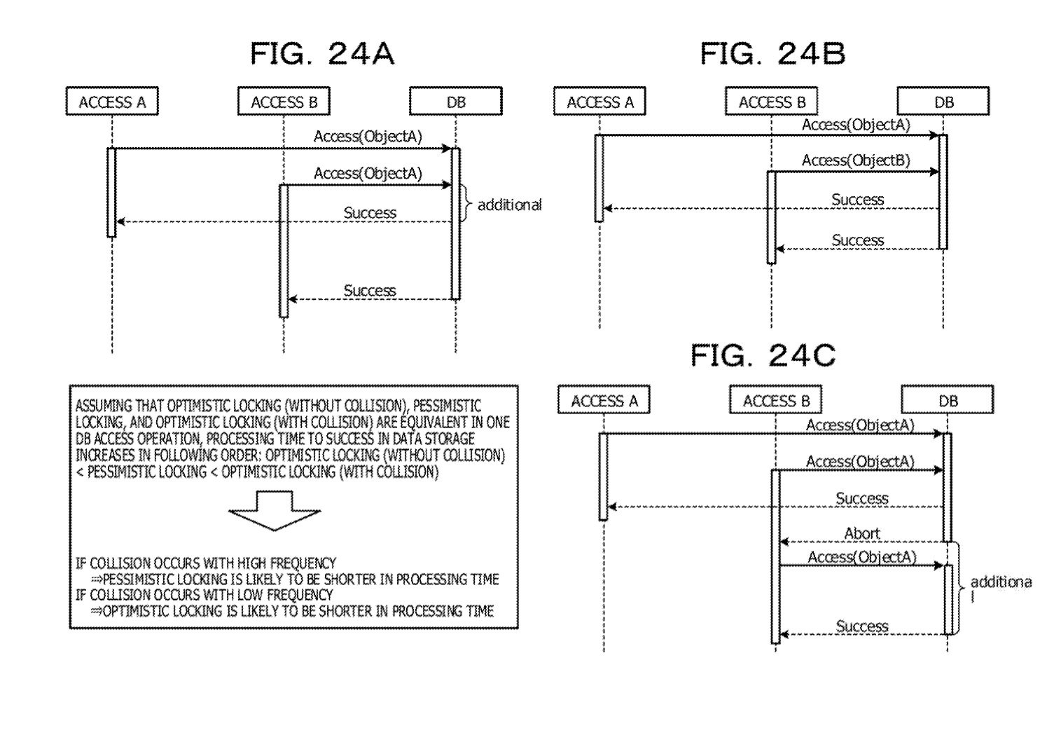

### DESCRIPTION OF EMBODIMENT

In a database storing a piece of lending information for a resource 3, an element which affects collision frequency changes unpredictably in real time. That is, the probability that the resource 3 managed in a row on the database is requested varies with a change in the number of users who wish to use the resource 3 concerned. For example, if there is an event in front of a station, users who wish to use the resource 3 in front of the station increase temporarily, and the collision frequency increases temporarily. Thus, in the database storing a piece of lending information for a resource, switching between optimistic locking and pessimistic locking based on a prediction on the collision frequency is impossible.

In one aspect, the present disclosure is intended to determine a lock method in response to a change in demand in a database storing a piece of lending information for a resource.

An embodiment related to an exclusive switching program and an exclusive switching method disclosed in the present application will be described below in detail with reference to the drawings. Note that the embodiment is not intended to limit a disclosed technique.

### EMBODIMENT

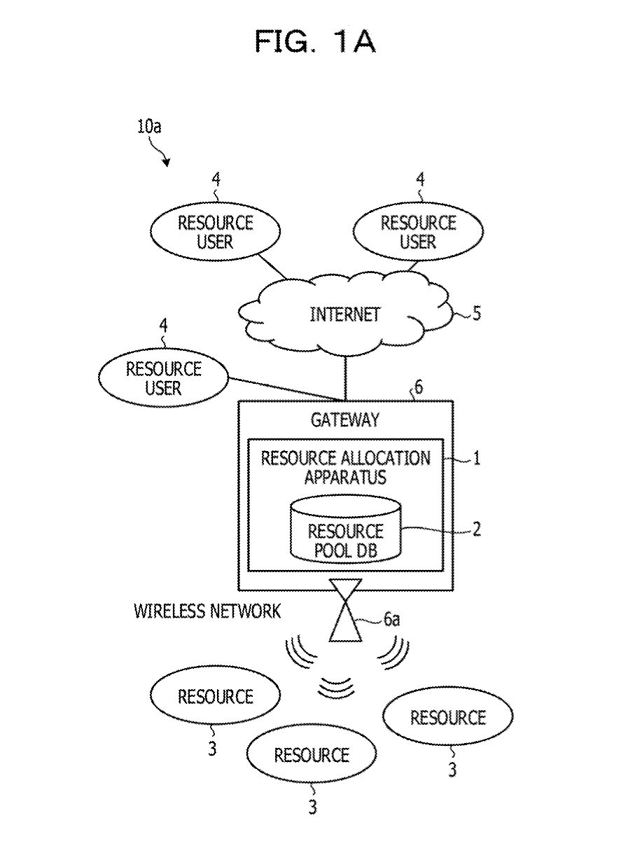

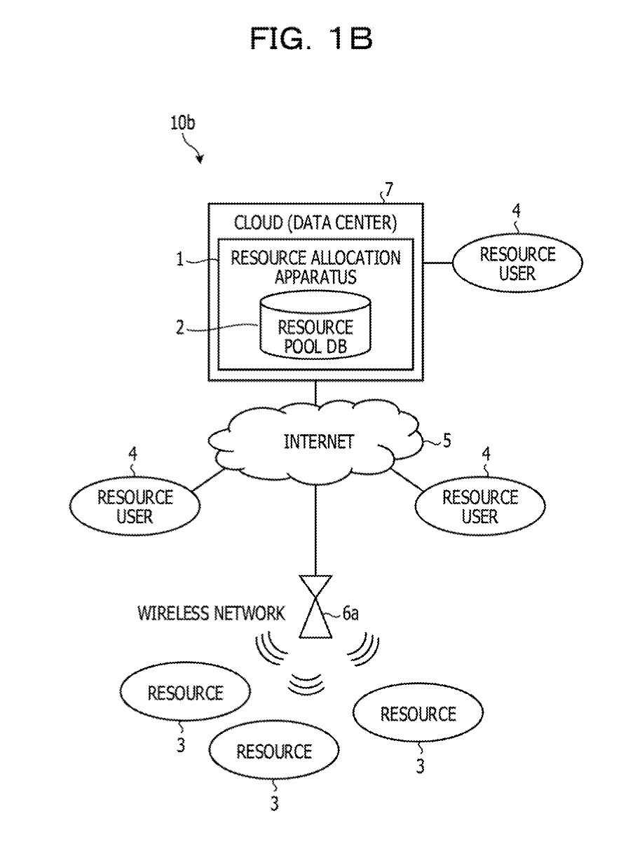

The configuration of a resource allocation system according to the embodiment will be described first. FIG. 1A is a first diagram illustrating the configuration of a resource allocation system according to the embodiment, and FIG. 1B is a second diagram illustrating the configuration of a resource allocation system according to the embodiment.

As illustrated in FIG. 1A, in a resource allocation system 10a, a gateway 6 which is arranged at the border between wireless communication and wired communication manages allocation of resources 3. The gateway 6 includes a resource allocation apparatus 1, and the resource allocation apparatus 1 includes a resource pool DB 2. The resource allocation apparatus 1 manages allocation of the resources 3 using the resource pool DB 2. The resource allocation apparatus 1 also switches a lock method in the resource pool DB 2. The resource pool DB 2 is a database storing a piece of allocation information for the resource 3.

The resource 3 communicates with the resource allocation apparatus 1 using wireless communication. The wireless communication is, for example, Wireless Fidelity (Wi-Fi) communication, Third Generation (3G) communication, or Long Term Evolution (LTE) communication. The resource 3 is, for example, a smartphone, a tablet terminal, or a notebook PC. A resource user 4 communicates with the resource allocation apparatus 1 directly or via the Internet 5.

As illustrated in FIG. 1B, in a resource allocation system 10b, a cloud 7, such as a data center, manages allocation of the resources 3. The cloud 7 includes the resource allocation apparatus 1. The resource 3 communicates with the resource allocation apparatus 1 via a base station 6a and the Internet 5. The resource user 4 communicates with the resource allocation apparatus 1 directly or via the Internet 5.

Note that the resource allocation apparatus 1 may be arranged at a location other than the gateway 6 and the cloud 7 where the resource allocation apparatus 1 is capable of communication with the resource 3 and the resource user 4.

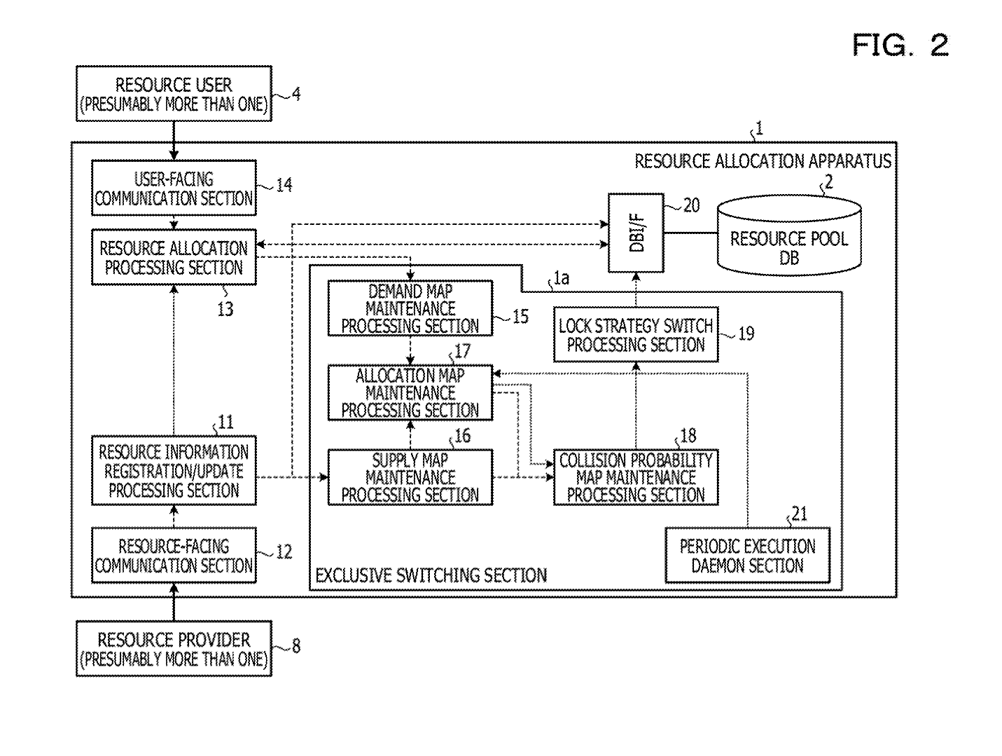

The functional configuration of the resource allocation apparatus 1 will be described. FIG. 2 is a diagram illustrating the functional configuration of the resource allocation apparatus 1. As illustrated in FIG. 2, the resource allocation apparatus 1 includes the resource pool DB 2, a resource information registration/update processing section 11, a resource-facing communication section 12, a resource allocation processing section 13, and a user-facing communication section 14. The resource allocation apparatus 1 also includes a demand map maintenance processing section 15, a supply map maintenance processing section 16, an allocation map maintenance processing section 17, a collision probability map maintenance processing section 18, a lock strategy switch processing section 19, a DB I/F 20, and a periodic execution daemon section 21. Note that, in FIG. 2, a dotted line indicates a control signal, a solid line indicates a flow of communication, and a broken line indicates a flow of data.

The resource information registration/update processing section 11 acquires a piece of information on the resource 3 provided by a resource provider 8 from the resource 3 via the resource-facing communication section 12, passes the acquired piece of resource information to the DB I/F 20, and requests registration of the piece of resource information in the resource pool DB 2 and updating of the resource pool DB 2. The resource information registration/update processing section 11 also passes the acquired piece of resource information to the supply map maintenance processing section 16. The resource information registration/update processing section 11 receives, from the resource 3, a request for registration of the resource 3 and notification of updating of a piece of positional information for the resource 3. The resource-facing communication section 12 communicates with the resource 3.

The resource allocation processing section 13 receives a resource allocation request from the resource user 4 via the user-facing communication section 14 and allocates the resource 3 to the resource user 4 based on the resource allocation request. The resource allocation processing section 13 requests the DB I/F 20 to secure the allocated resource 3. The resource allocation processing section 13 passes the received resource allocation request to the demand map maintenance processing section 15. The user-facing communication section 14 communicates with the resource user 4.

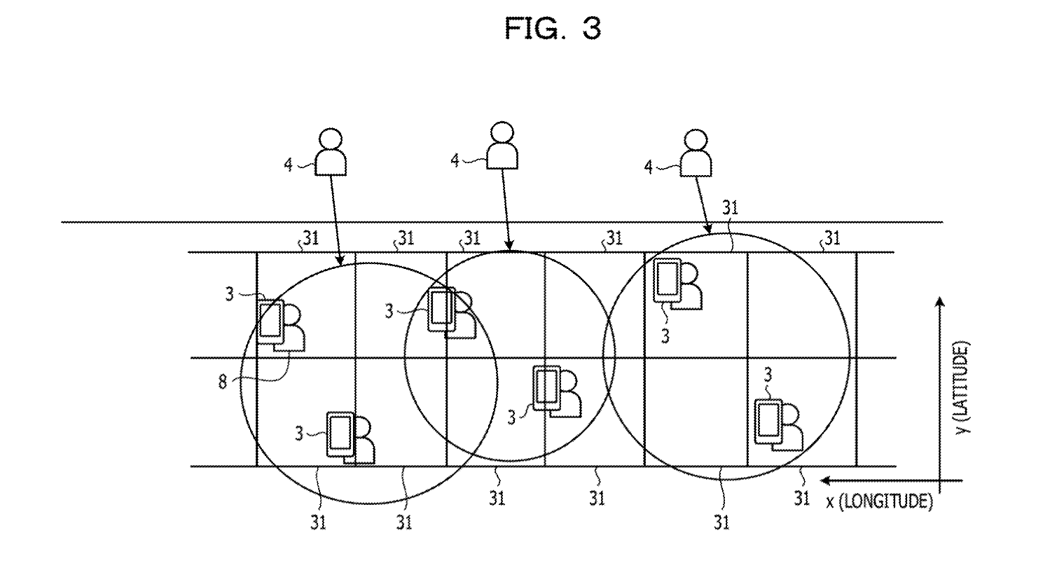

The resource pool DB 2 stores a piece of information on the resource 3 in association with a cell. The cell here refers to one of regions of fixed size, into which a region where the resources 3 are distributed. FIG. 3 is a diagram for explaining division into cells. The region where the resources 3 are distributed is divided into cells 31 by, for example, dividing the region into squares of fixed size based on latitude and longitude. In FIG. 3, the region where the resources 3 are distributed is divided into the cells 31 by dividing the region into pieces of fixed length in a latitude direction (a y direction) and of fixed width in a longitude direction (an x direction).

The size of the cell 31 is set such that the resource 3 does not move across a plurality of cells 31 within a short time. The resource user 4 may be made to designate the range of resources 3 to be used in units of cells or by latitude and longitude. Designation by latitude and longitude is converted into designation in units of cells.

The demand map maintenance processing section 15 performs a process of maintaining a demand map in response to a change in demand for the resources 3 which indicates a change in use of the resources 3 by the resource users 4. The demand map here refers to a table indicating a demand value for each cell 31 and is stored in a storage section in the demand map maintenance processing section 15.

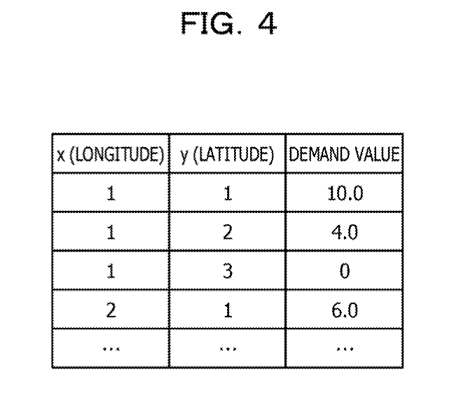

FIG. 4 is a chart illustrating an example of the demand map. As illustrated in FIG. 4, the demand map associates a demand value with a combination of x (longitude) and y (latitude). In the demand map, x (longitude) indicates a position of the cell 31 in the x direction, and y (latitude) indicates a position of the cell 31 in the y direction. A demand value is expressed as the number of demands. For example, the number of demands for the cell 31 at a position of “1” in the x direction and a position of “1” in the y direction is “10.0”. Note that a position of the cell 31 at a position of “p” in the x direction and a position of “q” in the y direction will be expressed as (p,q) below.

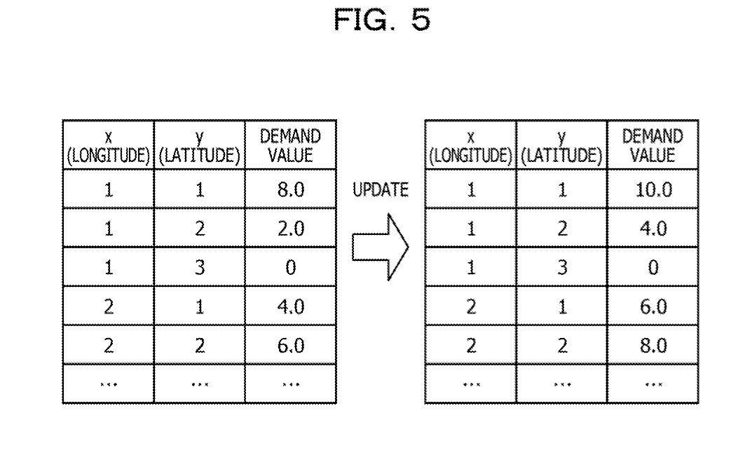

Upon receipt of a request for allocation of the resource 3 from the resource allocation processing section 13, the demand map maintenance processing section 15 updates the demand map for the cell(s) 31 included in an allocation range. FIG. 5 is a chart illustrating an example of updating of the demand map. FIG. 5 illustrates an example of updating in a case where a request for allocation of eight resources 3 for the range of (1≦x≦2) and (1≦y≦2) is received. The range of (1≦x≦2) and (1≦y≦2) includes four cells 31. The demand map maintenance processing section 15 adds 2 (=8/4) to a demand value for each of the four cells 31. For example, the number of demands for the cell 31 at (1,1) is updated from “8.0” to “10.0”.

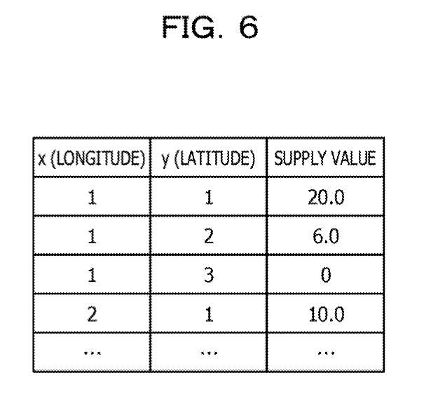

The supply map maintenance processing section 16 performs a process of maintaining a supply map in response to a change in supply of the resources 3 which indicates a change in provision of the resources 3 by the resource providers 8. The supply map here refers to a table indicating a supply value for each cell 31 and is stored in a storage section in the supply map maintenance processing section 16. FIG. 6 is a chart illustrating an example of the supply map. As illustrated in FIG. 6, the supply map associates a supply value with a combination of x (longitude) and y (latitude). A supply value is expressed as the quantity of resources 3 supplied. For example, the quantity of resources 3 supplied for the cell 31 at (1,1) is “20.0”.

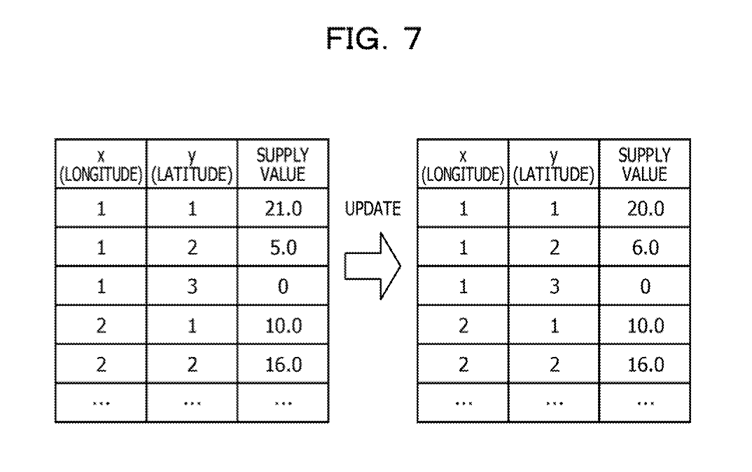

Upon receipt of notification of updating of a piece of positional information for the resource 3 from the resource information registration/update processing section 11, the supply map maintenance processing section 16 updates the supply map for the cell(s) 31 concerned with the notification of updating. FIG. 7 is a chart illustrating an example of updating of the supply map. FIG. 7 illustrates an example of updating in a case where one resource 3 moves from the cell 31 at (1,1) to the cell 31 at (1,2). As illustrated in FIG. 7, a supply value for the cell 31 at (1,1) is updated and reduced by 1 from “21.0” to “20.0”, and a supply value for the cell 31 at (1,2) is updated and increased by 1 from “5.0” to “6.0”.

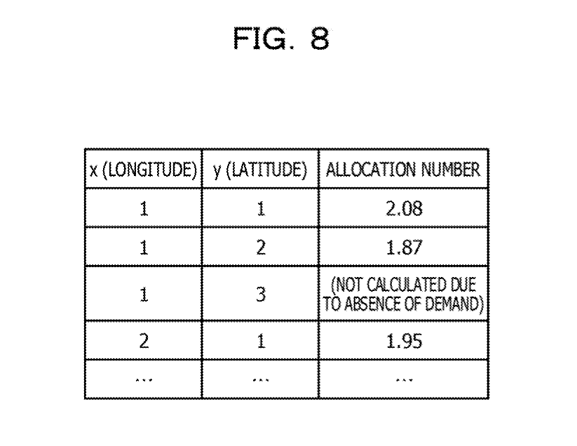

The allocation map maintenance processing section 17 performs a process of maintaining an allocation map based on the demand map and the supply map. The allocation map here refers to a table indicating an allocation number for each cell 31 included in a given region if there is a request for allocation of the resource 3 for the region and is stored in a storage section in the allocation map maintenance processing section 17. FIG. 8 is a chart illustrating an example of the allocation map in a case where a request for allocation of eight resources 3 for the range of (1≦x≦2) and (1≦y≦2) is received. As illustrated in FIG. 8, the allocation map associates an allocation number with a combination of x (longitude) and y (latitude). For example, an allocation number for the cell 31 at (1,1) is “2.08”.

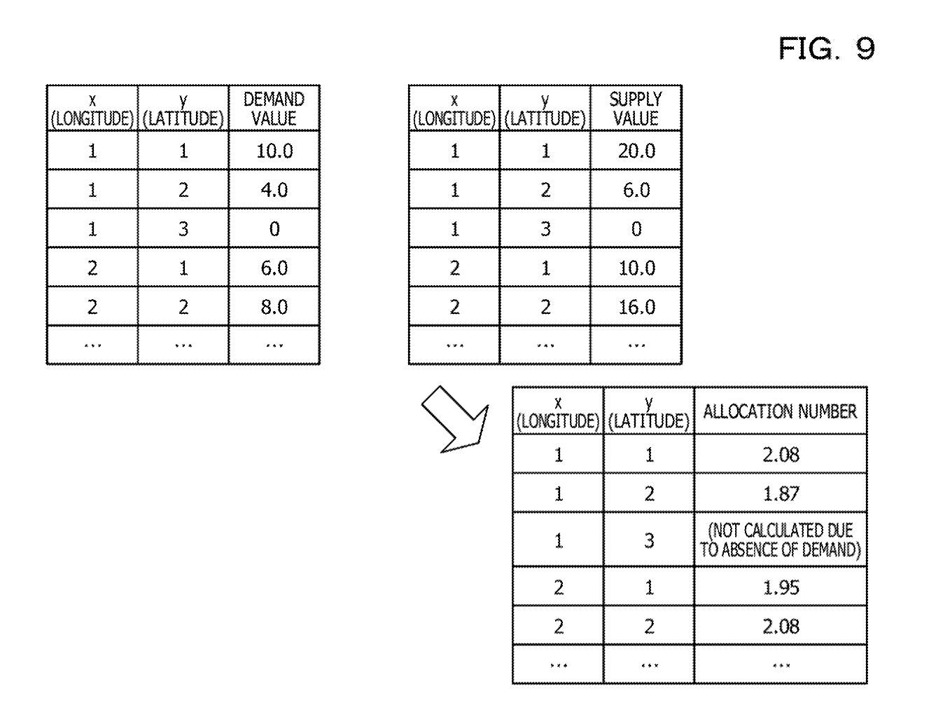

The allocation map maintenance processing section 17 periodically checks for a change in the demand map and a change in the supply map. If there is a change in the demand map or the supply map, the allocation map maintenance processing section 17 newly creates an allocation map. FIG. 9 is a chart illustrating an example of creation of the allocation map. The allocation map maintenance processing section 17 calculates, for each cell 31, m_{xy}=a demand value/a supply value and calculates a selection ratio n_{xy}=sum(m_{xy})−m_{xy} based on m_{xy}. In the equation, sum represents the sum of values for the target cells 31. The target cell 31 is the cell 31 included in a region, for which allocation of the resource(s) 3 is requested. The allocation map maintenance processing section 17 calculates an allocation number a_{xy} for each cell 31 by a_{xy}=k×(n_{xy}/sum(n_{xy})). In the equation, k represents the quantity of resources 3 requested.

For example, if a request for allocation of eight resources 3 for the range of (1≦x≦2) and (1≦y≦2) is received, m₁₁ is calculated to be 10.0/20.0=1/2, and n₁₁ is calculated to be sum(m₁₁)−m₁₁=(1/2+2/3+3/5+1/2)−1/2=1.77, for the cell 31 at (1,1). Additionally, a₁₁ is calculated to be 8×(1.77/(1.77+1.6+1.67+1.77))=2.08. Note that since there is no demand for the cell 31 at (1,3), an allocation number is not calculated. That is, the allocation map maintenance processing section 17 does not calculate an allocation number for the cell 31, for which there is no demand.

The allocation map maintenance processing section 17 periodically checks for a change in the supply map. If there is a change in the supply map, the allocation map maintenance processing section 17 updates the allocation map. A process of checking for a change and updating an allocation number for all the cells 31 is time-consuming. For this reason, the allocation map maintenance processing section 17 does not check for changes in all the cells 31 every time but, for example, checks for changes in half of all the cells 31 and updates the allocation map at one time.

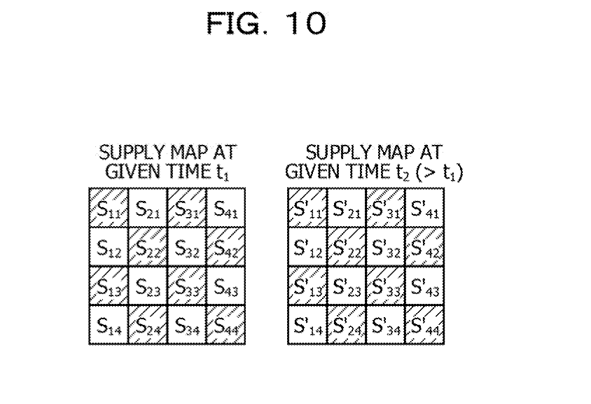

FIG. 10 is a chart for explaining a method for checking for changes in half of the cells 31 and updating the allocation map at one time. In FIG. 10, S_{xy} represents the quantity supplied of resources 3 for the cell 31 at (x,y) at time t₁, and S′_{xy} represents the quantity supplied of resources 3 for the cell 31 at (x,y) at time t₂. The allocation map maintenance processing section 17 alternately checks the shaded cells 31 and the unshaded cells 31.

That is, the allocation map maintenance processing section 17 periodically executes the process and switches the target cells 31 every time periodic execution operation is performed. For example, if periodic execution operation is performed at tₙ (n>0), the allocation map maintenance processing section 17 sets the cells 31 below as the target cells 31.

If n mod 2=0, the cells 31 have coordinates satisfying (x mod 2=0 and y mod 2=0) or (x mod 2=1 and y mod 2=1).

If n mod 2=1, the cells 31 have coordinates satisfying (x mod 2=0 and y mod 2=1) or (x mod 2=1 and y mod 2=0).

Referring to FIG. 10, the allocation map maintenance processing section 17 sets each shaded cell 31 as the target cell 31 and checks for a change in the quantity supplied of resources 3 at time t₁ and sets each unshaded cell 31 as the target cell 31 and checks for a change in the quantity supplied of resources 3 at time t₂.

For example, the allocation map maintenance processing section 17 compares |S′₂₁−S₂₁| with a threshold at time t₂. If |S′₂₁−S₂₁|>the threshold, the allocation map maintenance processing section 17 judges that a quantity supplied for the cell 31 at (2,1) has changed. Due to limitations placed by geographic movement that is continuous movement on a two-dimensional plane on movement of the resource 3, if there is a change in a quantity supplied for the given cell 31, there is a high possibility of a change in a quantity supplied for the surrounding cell 31. For this reason, the allocation map maintenance processing section 17 prunes the process of checking for a change in a quantity supplied.

That is, if the allocation map maintenance processing section 17 judges that there is a change in a quantity supplied for the given cell 31, the allocation map maintenance processing section 17 judges that there is a change in a quantity supplied for the surrounding cell 31, without comparison with the threshold for the surrounding cell 31. The surrounding cell 31 here refers to, for example, the cell 31 on the left, right, top, or bottom of the given cell 31. Note that if a period (t₂−t₁) for checking for a change in the supply map is too long, the possibility of the resource 3 moving across a plurality of cells 31 increases, and effects of pruning decrease. For this reason, the period for checking for a change in the supply map is set based on movement velocity of the resource 3.

The collision probability map maintenance processing section 18 performs a process of maintaining a collision probability map based on the allocation map. The collision probability map here refers to a table which associates the probability of a fight over the resource 3 with each cell 31 and is stored in a storage section in the collision probability map maintenance processing section 18. The probability of a fight over the resource 3 is the probability of a collision over access to the same data in the resource pool DB 2.

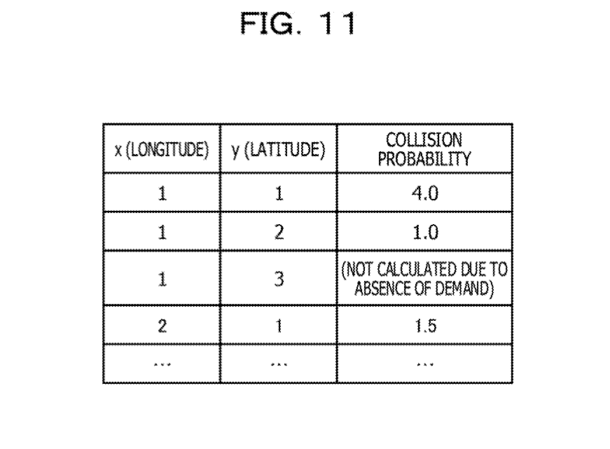

FIG. 11 is a chart illustrating an example of the collision probability map. As illustrated in FIG. 11, the collision probability map associates a collision probability with a combination of x (longitude) and y (latitude). A collision probability is an allocation number/(a supply value−the allocation number). For example, a collision probability for the cell 31 at (1,1) is “4.0”.

The lock strategy switch processing section 19 updates a lock strategy map based on the collision probability map and updates a lock method in the resource pool DB 2 based on a result of the updating. The lock strategy map here refers to a table which associates a lock method with each cell 31 and is stored in a storage section in the lock strategy switch processing section 19.

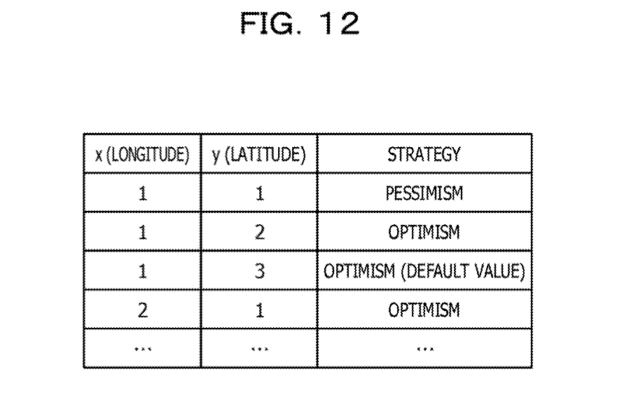

FIG. 12 is a chart illustrating an example of the lock strategy map. As illustrated in FIG. 12, the lock strategy map associates a strategy with a combination of x (longitude) and y (latitude). A strategy is a lock method in the resource pool DB 2 for the resource(s) 3 belonging to the corresponding cell 31. For example, a strategy for the cell 31 at (1,1) is “pessimism”. Note that a default value for a strategy is “optimism”.

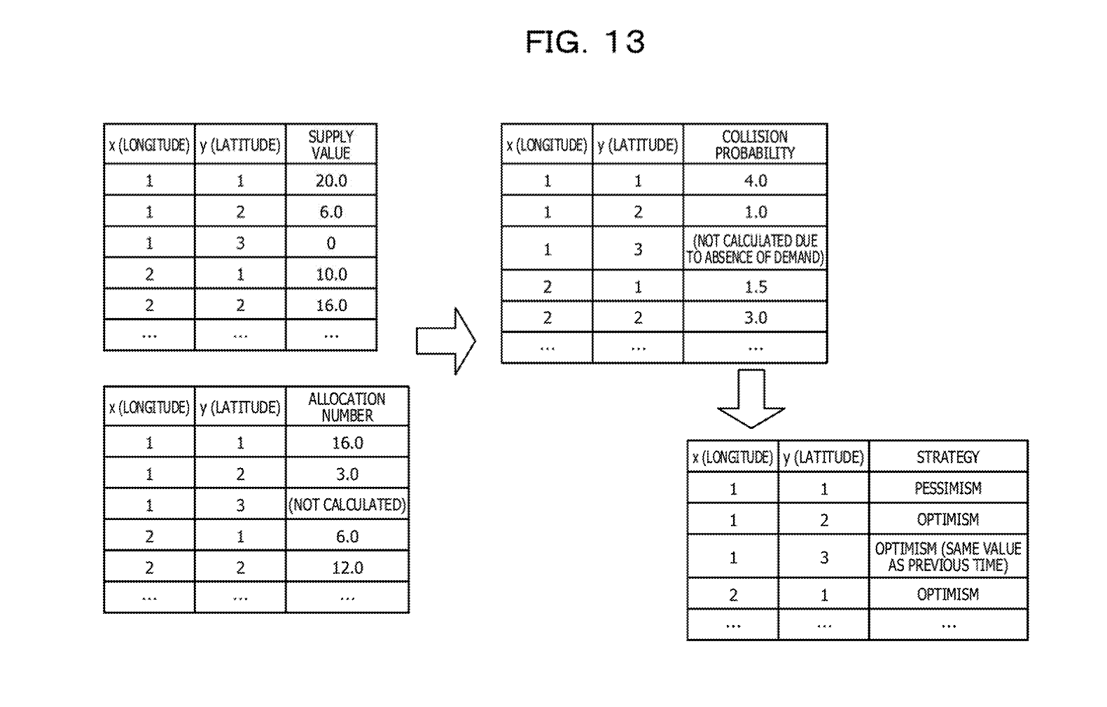

FIG. 13 is a chart illustrating an example of creation of the collision probability map and the lock strategy map. As illustrated in FIG. 13, the collision probability map is created from the supply map and the allocation map, and the lock strategy map is created from the collision probability map. A strategy in the lock strategy map is determined by comparing a collision probability with a threshold. In FIG. 13, the threshold is 3.0, a strategy for the cell 31 at (1,1) is “pessimism”, and strategies for the cells 31 at (1,2) and (2,1) are “optimism”.

Note that a collision probability is not calculated if there is no demand, and an allocation number is not calculated. That is, the collision probability map maintenance processing section 18 does not calculate a collision probability for the cell 31, for which there is no demand. The lock strategy switch processing section 19 leaves a previous strategy unupdated for the cell 31, for which a collision probability is not calculated. In FIG. 13, a strategy for the cell 31 at (1,3) is “optimism”, which is the same as the previous time.

The lock strategy switch processing section 19 instructs the DB I/F 20 to change a lock method in the resource pool DB 2 for the resource(s) 3 present in the cell 31, for which a strategy is changed in the lock strategy map. The DB I/F 20 manages the resource pool DB 2 and operates as an interface with the resource pool DB 2.

The periodic execution daemon section 21 periodically activates the allocation map maintenance processing section 17 such that the allocation map, the collision probability map, and the lock strategy map are updated if there is a change in the demand map or the supply map.

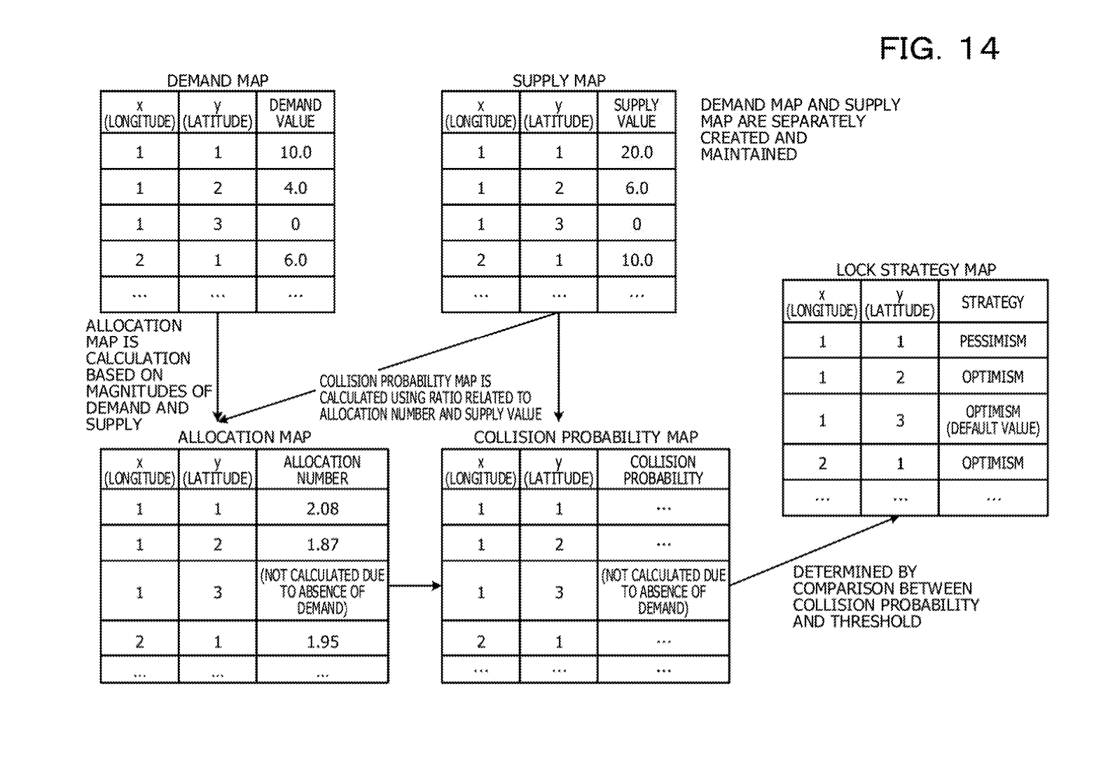

FIG. 14 is a chart illustrating a correlation among maps. As illustrated in FIG. 14, the demand map and the supply map are separately created and maintained. The allocation map is calculated based on the magnitudes of demand and supply. The collision probability map is calculated using a ratio related to an allocation number and a supply value. The lock strategy map is determined by comparing a collision probability with the threshold.

Note that the demand map maintenance processing section 15, the supply map maintenance processing section 16, the allocation map maintenance processing section 17, the collision probability map maintenance processing section 18, the lock strategy switch processing section 19, and the periodic execution daemon section 21 operate as an exclusive switching section 1a which switches a lock method in the resource pool DB 2.

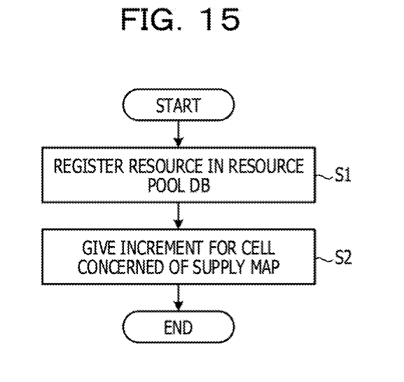

The flow of a resource registration process will be described. FIG. 15 is a flowchart illustrating the flow of the resource registration process. Note that the resource registration process is executed in response to a request for registration of the resource 3 from the resource provider 8. As illustrated in FIG. 15, the resource information registration/update processing section 11 registers the resource 3, for which the request for registration is received, in the resource pool DB 2 via the DB I/F 20 (step S1). The supply map maintenance processing section 16 gives an increment for the cell 31 concerned of the supply map (step S2).

As described above, when the resource information registration/update processing section 11 registers the resource 3 in the resource pool DB 2, the supply map maintenance processing section 16 gives an increment for the cell 31 concerned of the supply map. This allows the exclusive switching section 1a to keep the supply map up to date.

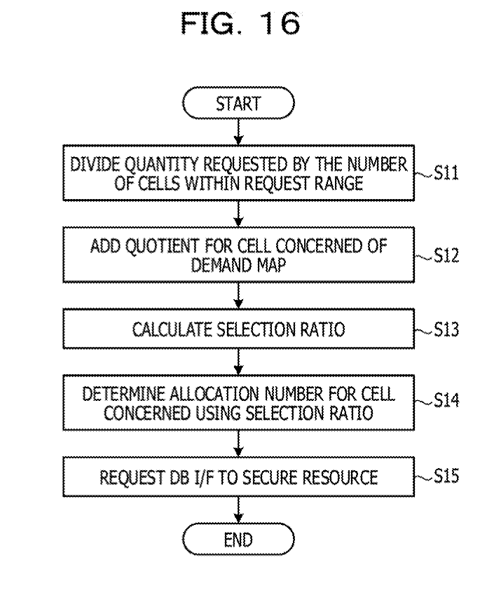

The flow of a resource allocation process will be described. FIG. 16 is a flowchart illustrating the flow of the resource allocation process. Note that the resource allocation process is executed in response to a request for allocation of the resource 3 from the resource user 4. As illustrated in FIG. 16, the demand map maintenance processing section 15 divides a quantity requested by the number of cells within a request range based on the allocation request (step S11) and adds a quotient for the cell(s) 31 concerned of the demand map (step S12).

The resource allocation processing section 13 calculates a selection ratio n_{xy} for each cell 31 at (x,y) concerned (step S13) and determines an allocation number a_{xy} for the cell 31 concerned using the calculated selection ratio n_{xy} (step S14). The resource allocation processing section 13 requests the DB I/F 20 to secure the resource(s) 3 (step S15).

As described above, when the resource allocation processing section 13 allocates the resource(s) 3, the demand map maintenance processing section 15 updates the cell(s) 31 concerned of the demand map. This allows the exclusive switching section 1a to keep the demand map up to date.

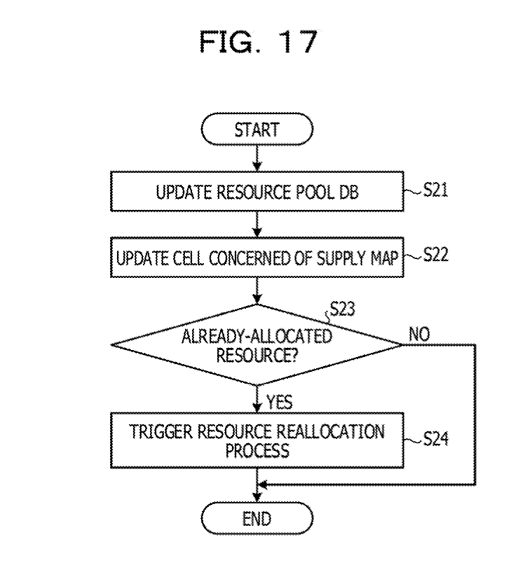

The flow of a resource state information updating process will be described. FIG. 17 is a flowchart illustrating the flow of the resource state information updating process. Note that the resource state information updating process is executed in response to a request for updating of a piece of state information on the resource 3 from the resource provider 8. As illustrated in FIG. 17, the resource information registration/update processing section 11 updates the resource pool DB 2 via the DB I/F 20 in response to a request for updating of a piece of state information on the resource 3 (step S21).

The supply map maintenance processing section 16 updates the cell 31 concerned of the supply map (step S22) and judges whether the resource 3, for which the piece of state information is updated, is the already-allocated resource 3 (step S23). If a result of the judgment is that the resource 3 is not the already-allocated resource 3, the supply map maintenance processing section 16 ends the process. On the other hand, if the resource 3 is the already-allocated resource 3, the supply map maintenance processing section 16 triggers a resource reallocation process (step S24) and ends the process.

As described above, when the resource information registration/update processing section 11 updates the resource pool DB 2 with regard to the state of the resource 3, the supply map maintenance processing section 16 updates the cell 31 concerned of the supply map. This allows the exclusive switching section 1a to keep the supply map up to date.

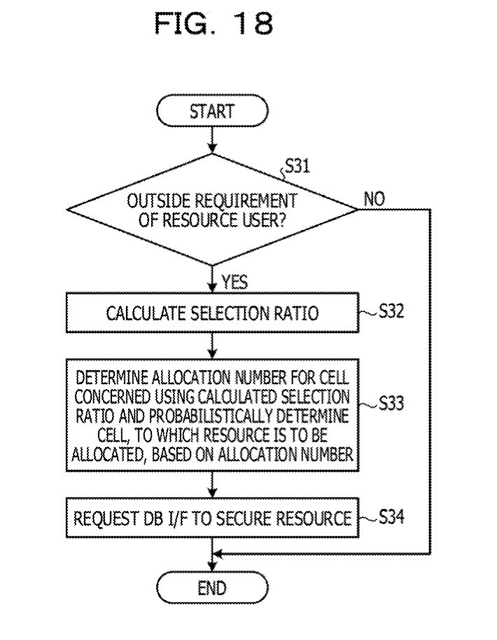

FIG. 18 is a flowchart illustrating the flow of the resource reallocation process. The resource reallocation process is activated in the resource state information updating process. As illustrated in FIG. 18, the resource information registration/update processing section 11 judges whether the resource 3, for which a piece of state information is updated, has fallen outside a requirement of the resource user 4 (step S31). If the resource 3 falls within the requirement, the resource information registration/update processing section 11 ends the process.

On the other hand, if the resource 3 has fallen outside the requirement, the resource information registration/update processing section 11 calculates a selection ratio n_{xy} for each of the cell(s) 31 at (x,y) concerned (step S32). The resource information registration/update processing section 11 determines an allocation number a_{xy} for the cell 31 concerned using each calculated selection ratio n_{xy} and probabilistically determines the cell 31, to which the resource 3 is to be allocated, based on the allocation number(s) a_{xy} (step S33). The resource information registration/update processing section 11 requests the DB I/F 20 to secure the resource 3 (step S34).

As described above, if the already-allocated resource 3 moves and falls outside a requirement of the resource user 4, the resource information registration/update processing section 11 is capable of meeting demands of the resource user 4 by reallocating the new resource 3.

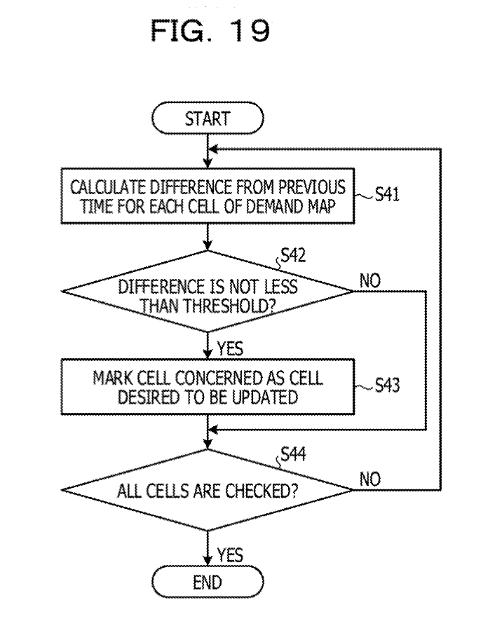

The flow of a process of maintaining the allocation map and the collision probability map if a change in the demand map is found will be described. FIG. 19 is a flowchart illustrating the flow of the process of maintaining the allocation map and the collision probability map if a change in the demand map is found. The process illustrated in FIG. 19 is periodically executed by the periodic execution daemon section 21.

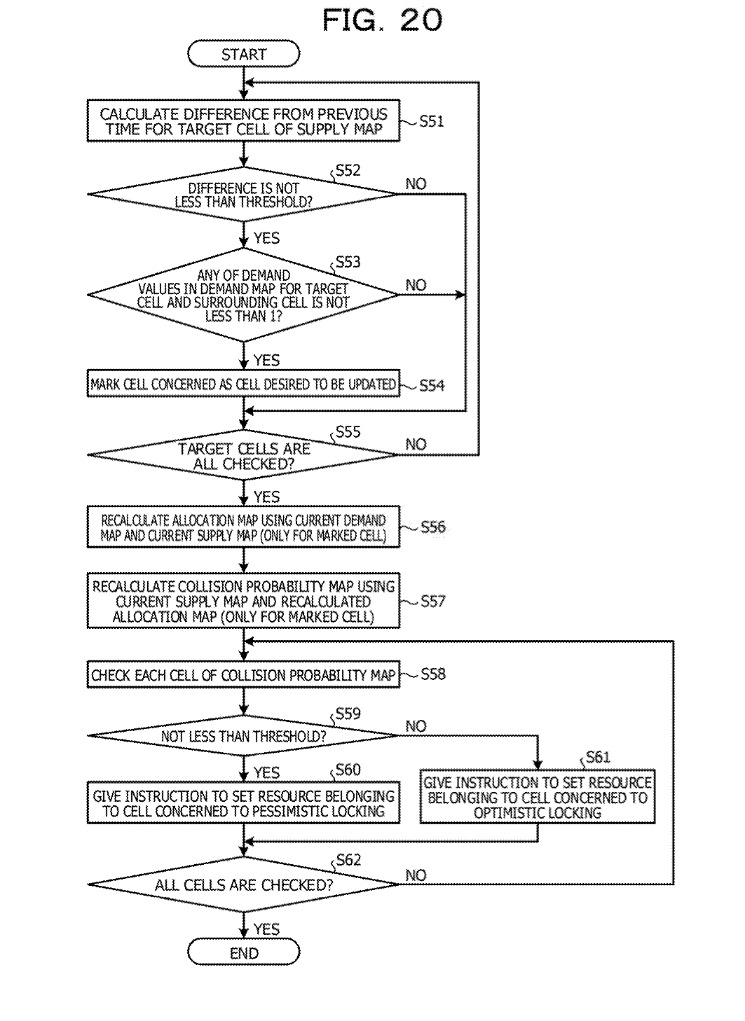

As illustrated in FIG. 19, the allocation map maintenance processing section 17 calculates a difference from the previous time for each cell 31 of the demand map (step S41) and judges whether the difference is not less than a threshold (step S42). If a result of the judgment is that the difference is not less than the threshold, the allocation map maintenance processing section 17 marks the cell 31 concerned as the cell 31 desired to be updated (step S43). Note that a process of maintaining the allocation map and the collision probability map and a process of determining a lock method are performed for the cell 31 marked as the cell 31 desired to be updated in a process in FIG. 20 (to be described later).

The allocation map maintenance processing section 17 judges whether all the cells 31 in the demand map are checked (step S44). The allocation map maintenance processing section 17 ends the process if all the cells 31 are checked and returns to step S41 if the unchecked cell 31 is present.

As described above, the allocation map maintenance processing section 17 is capable of designating the cell 31, for which a lock method is desired to be updated, by marking the cell 31, for which a difference in demand from the previous time is not less than the threshold.

The flow of a process of maintaining the allocation map and the collision probability map if a change in the supply map is found will be described. FIG. 20 is a flowchart illustrating the flow of the process of maintaining the allocation map and the collision probability map if a change in the supply map is found. The process illustrated in FIG. 20 is periodically executed by the periodic execution daemon section 21.

As illustrated in FIG. 20, the allocation map maintenance processing section 17 calculates a difference from the previous time for each target cell 31 of the supply map (step S51) and judges whether the difference is not less than a threshold (step S52). The target cell 31 here refers to the cell 31, for which a difference is calculated by one periodic execution operation, and half of all the cells 31 are the target cells 31. If the difference is not less than the threshold, the allocation map maintenance processing section 17 advances to step S55.

On the other hand, if the difference is not less than the threshold, the allocation map maintenance processing section 17 judges, for each of the target cell 31 and the surrounding cells 31, whether a demand value in the demand map is not less than 1 (step S53). If the demand values are less than 1, the allocation map maintenance processing section 17 advances to step S55. On the other hand, if any demand value is not less than 1, the allocation map maintenance processing section 17 marks the cell 31 concerned as the cell 31 desired to be updated (step S54).

The allocation map maintenance processing section 17 judges whether the target cells 31 are all checked (step S55). If the unchecked target cell 31 is present, the allocation map maintenance processing section 17 returns to step S51. On the other hand, if the target cells 31 are all checked, the allocation map maintenance processing section 17 recalculates the allocation map using the current demand map and the current supply map (step S56). At this time, the allocation map maintenance processing section 17 performs the recalculation only on the marked cell(s) 31.

The collision probability map maintenance processing section 18 recalculates the collision probability map using the current supply map and the recalculated allocation map (step S57). At this time, the collision probability map maintenance processing section 18 performs the recalculation only on the marked cell(s) 31. The lock strategy switch processing section 19 checks each cell 31 of the collision probability map (step S58) and judges whether a collision probability is not less than a threshold (step S59).

If a result of the judgment is that the collision probability is not less than the threshold, the lock strategy switch processing section 19 instructs the DB I/F 20 to set the resource(s) 3 belonging to the cell 31 concerned to pessimistic locking (step S60). On the other hand, if the collision probability is less than the threshold, the lock strategy switch processing section 19 instructs the DB I/F 20 to set the resource(s) 3 belonging to the cell 31 concerned to optimistic locking (step S61). The lock strategy switch processing section 19 judges whether all the cells 31 are checked (step S62). The lock strategy switch processing section 19 returns to step S58 if the unchecked cell 31 is present and ends the process if all the cells 31 are checked.

As described above, the allocation map maintenance processing section 17 is capable of efficiently recalculating the allocation map by recalculating the allocation map only for the marked cell(s) 31.

As has been described above, in the embodiment, the demand map maintenance processing section 15 maintains the demand map, and the supply map maintenance processing section 16 maintains the supply map. The allocation map maintenance processing section 17 maintains the allocation map using the demand map and the supply map. The collision probability map maintenance processing section 18 maintains the collision probability map using the supply map and the allocation map. The lock strategy switch processing section 19 determines a lock method in the resource pool DB 2 using the collision probability map. Thus, the exclusive switching section 1a is capable of determining a lock method in the resource pool DB 2 in response to a change in demand or supply.

In the embodiment, the allocation map maintenance processing section 17 marks the cell 31 that has a demand value not less than 1 as the cell 31 desired to be updated, among the cell 31 that has a change in a supply value and the surrounding cells 31. The allocation map maintenance processing section 17 recalculates the allocation map only for the marked cell 31, and the collision probability map maintenance processing section 18 recalculates the collision probability map only for the marked cell 31. Thus, the exclusive switching section 1a is capable of reducing the load of the process of determining a lock method in the resource pool DB 2.

Note that although the exclusive switching section 1a has been described in the embodiment, an exclusive switching program having the same functions is obtained by implementing the configuration of the exclusive switching section 1a by software. A computer which executes the exclusive switching program will be described.

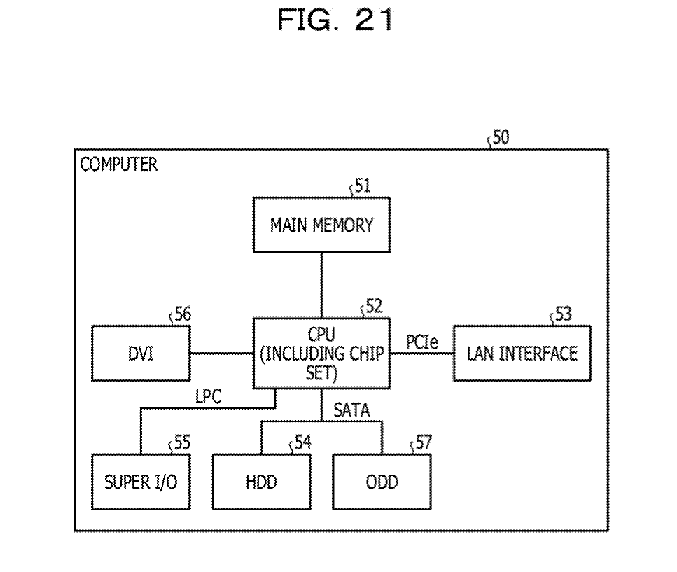

FIG. 21 is a diagram illustrating the hardware configuration of a computer which executes an exclusive switching program according to the embodiment. As illustrated in FIG. 21, a computer 50 includes a main memory 51, a central processing unit (CPU) 52, a local area network (LAN) interface 53, and a hard disk drive (HDD) 54. The computer 50 also includes a super input/output (I/O) 55, a digital visual interface (DVI) 56, and an optical disk drive (ODD) 57.

The main memory 51 is a memory which stores a program, a result during execution of the program, and the like. The CPU 52 is a central processing unit which reads out a program from the main memory 51 and executes the program. The CPU 52 includes a chip set having a memory controller.

The LAN interface 53 is an interface for connecting the computer 50 to another computer via a LAN. The HDD 54 is a disk drive which stores a program and data, and the super I/O 55 is an interface for connecting to an input device, such as a mouse or a keyboard. The DVI 56 is an interface for connecting to a liquid crystal display device, and the ODD 57 is a device for reading from or writing to a DVD.

The LAN interface 53 is connected to the CPU 52 by PCI Express (PCIe), and the HDD 54 and the ODD 57 are connected to the CPU 52 by serial advanced technology attachment (SATA). The super I/O 55 is connected to the CPU 52 by low pin count (LPC).

An exclusive switching program to be executed in the computer 50 is stored in a DVD, and is read out from the DVD and installed on the computer 50 by the ODD 57. Alternatively, the exclusive switching program is stored in a database or the like of another computer system connected via the LAN interface 53, and is read out from the database and installed on the computer 50. The installed exclusive switching program is stored in the HDD 54, is read out onto the main memory 51, and is executed by the CPU 52.

A case where the resource 3 moves to change supply has been described in the embodiment. The present disclosure, however, is not limited to this and is also applicable to a case where only demand changes without any change in supply.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A non-transitory computer-readable storage medium storing an exclusive switching program that causes a computer to execute a process comprising:
obtaining supply information indicating a plurality of quantities of resources being available in a plurality of regions respectively;
obtaining demand information indicating a plurality of demand quantities of the resources for the plurality of regions respectively;
calculating a plurality of index values corresponding to the plurality of regions respectively based on the supply information and the demand information, each of the plurality of index values indicating probability of a collision of the resources in each of the plurality of regions; and
determining, for each of a plurality of regions, a lock method to be applied in an exclusive access control for the resources based on the plurality of index values among from a plurality of lock methods.

2. The non-transitory computer-readable storage medium according to claim 1, wherein
the plurality of lock methods includes an optimistic lock and a pessimistic lock.

3. The non-transitory computer-readable storage medium according to claim 1, wherein
each of the plurality of demand quantities indicates a number of users requesting resources.

4. The non-transitory computer-readable storage medium according to claim 1, wherein
the calculating is executed when at least one of the plurality of demand quantities is changed.

5. The non-transitory computer-readable storage medium according to claim 1, wherein
the determined lock methods applied for a resource database used for a management of a usage condition of the resources.

6. The non-transitory computer-readable storage medium according to claim 1, wherein
the resources include at least one of an information processing apparatus including a sensor, a wireless communication device and a display device mounted in a vehicle.

7. The non-transitory computer-readable storage medium according to claim 1, wherein
the calculating is executed when at least one of the plurality of quantities of resources indicated by the supply information are changed.

8. The non-transitory computer-readable storage medium according to claim 1, wherein
the resources are resources that moves geographically; and wherein
the collision probability is calculated for a part of the plurality of regions, using a limitation on resource geographic movement.

9. The non-transitory computer-readable storage medium according to claim 1, wherein
the collision probability is calculated for a part of the plurality of regions, based on whether each of the plurality of demand quantities is zero or not.

10. An exclusive switching method executed by a computer, the exclusive switching method comprising:
obtaining supply information indicating a plurality of quantities of resources being available in a plurality of regions respectively;
obtaining demand information indicating a plurality of demand quantities of the resources for the plurality of regions respectively;
calculating a plurality of index values corresponding to the plurality of regions respectively based on the supply information and the demand information, each of the plurality of index values indicating probability of a collision of the resources in each of the plurality of regions; and
determining, for each of a plurality of regions, a lock method to be applied in an exclusive access control for the resources based on the plurality of index values among from a plurality of lock methods.

11. An exclusive switching apparatus comprising:
a memory that stores supply information and demand information, the supply information indicating a plurality of quantities of resources being available in a plurality of regions respectively, the demand information indicating a plurality of demand quantities of the resources for the plurality of regions respectively; and
a processor coupled to the memory and the processor configured to:
calculate a plurality of index values corresponding to the plurality of regions respectively based on the supply information and the demand information, each of the plurality of index values indicating probability of a collision of the resources in each of the plurality of regions; and
determine, for each of a plurality of regions, a lock method to be applied in an exclusive access control for the resources based on the plurality of index values among from a plurality of lock methods.
